(19) United States
(12) Patent Application Publication
(10) Pub. No.: US 2011/0291957 A1
(43) Pub. Date: Dec. 1, 2011

(54) TOUCH-TYPE TRANSPARENT KEYBOARD

(75) Inventors: KUN-TSAN WU, Shindian (TW); LI-WEN TIEN, Shindian (TW)

(73) Assignee: FIH (HONG KONG) LIMITED, Kowloon (HK)

(21) Appl. No.: 12/889,578

(22) Filed: Sep. 24, 2010

(30) Foreign Application Priority Data
May 28, 2010 (CN) 201010185708.0

(51) Int. Cl. G06F 3/041

(52) U.S. Cl. 345/173

(57) ABSTRACT

A touch-type transparent keyboard is for use with an electronic device. The touch-type transparent keyboard includes a touch screen, a control module electrically connecting to the touch screen, a transparent plate and a writing pad. The transparent plate includes a number of key icons and a driver circuit electrically connecting the key icons to the control module. The writing pad and the touch screen are disposed on the transparent plate; the writing pad electrically connects to the control module. The control module triggers the driver circuit to illuminate, the key icons that are displayed through the touch screen.

### CROSS-REFERENCE TO RELATED APPLICATIONS

This application is one of the six related co-pending U.S. patent applications listed below. All listed applications have the same assignee and were concurrently filed herewith. The disclosure of each of the listed applications is incorporated by reference into all the other listed applications.

| Attorney Docket No. | Title | Inventors |
|---|---|---|
| US33515 | TOUCH-TYPE TRANSPARENT | Wu et al. |
| | KEYBOARD | |
| US33516 | TOUCH-TYPE TRANSPARENT | Wu et al. |
| | KEYBOARD | |
| US33517 | TOUCH-TYPE TRANSPARENT | Wu et al. |
| | KEYBOARD | |
| US33518 | TOUCH-TYPE TRANSPARENT | Wu et al. |
| | KEYBOARD | |
| US33519 | TOUCH-TYPE TRANSPARENT | Wu et al. |
| | KEYBOARD | |
| US33520 | TOUCH-TYPE TRANSPARENT | Wu et al. |
| | KEYBOARD | |

### BACKGROUND

1. Technical Field

The present disclosure generally relates to touch-type transparent keyboards, and particularly, to a touch-type transparent keyboard for use with an electronic device.

2. Description of Related Art

For operating electronic devices, keyboards, mice, trackballs or remote controls are important user interfaces for controlling cursors or inputting instructions. Currently, standard mechanical keyboards are widely for use with industrial or residential fields for inputting information into computers. Mechanical keyboards may make noise while being used for typing. Moreover, gaps between keys are a gathering point for all kinds of contaminants that difficult to dislodge.

Therefore, there is a room for improvement within the art.

### BRIEF DESCRIPTION OF THE DRAWINGS

Many aspects of the touch-type transparent keyboard can be better understood with reference to the following drawings. The components in the drawings are not necessarily to scale, the emphasis instead being placed upon clearly illustrating the touch-type transparent keyboard. Moreover, in the drawings, like reference numerals designate corresponding parts throughout the several views.

FIG. 1 is a partially exploded, isometric view of a touch-type transparent keyboard, according to an exemplary embodiment.

FIG. 2 is a cross-sectional view of the touch-type transparent keyboard shown in FIG. 1.

FIG. 3 is an assembled view of the touch-type transparent keyboard shown in FIG. 1.

FIG. 4 is an assembled view of the touch-type transparent keyboard shown in FIG. 3, but shown from another aspect.

### DETAILED DESCRIPTION

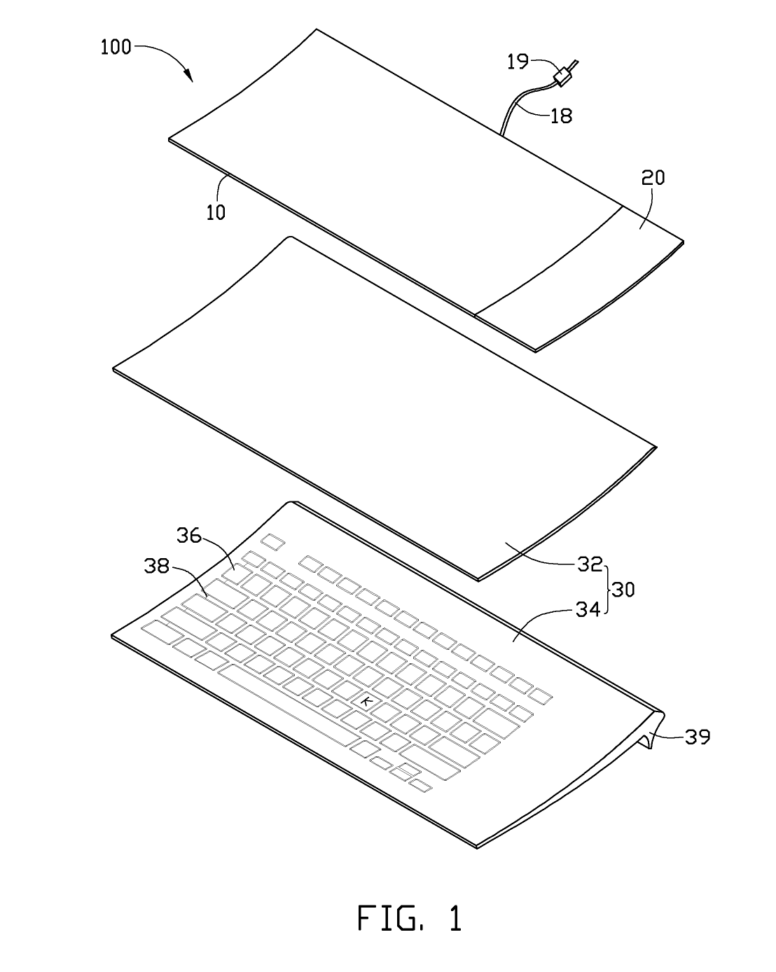

Referring FIG. 1, the present disclosure provides a touch-type transparent keyboard 100 for use with an electronic device. The electronic device includes but is not limited to a smart phone, a mobile phone, a personal digital assistant (PDA), an e-book reader, or a notebook computer. In an exemplary embodiment, the touch-type transparent keyboard 100 includes a touch screen 10, a writing pad 20, and a transparent plate 30. The writing pad 20 connects to the touch screen 10, and both of them are disposed on the transparent plate 30 for forming the touch-type transparent keyboard 100.

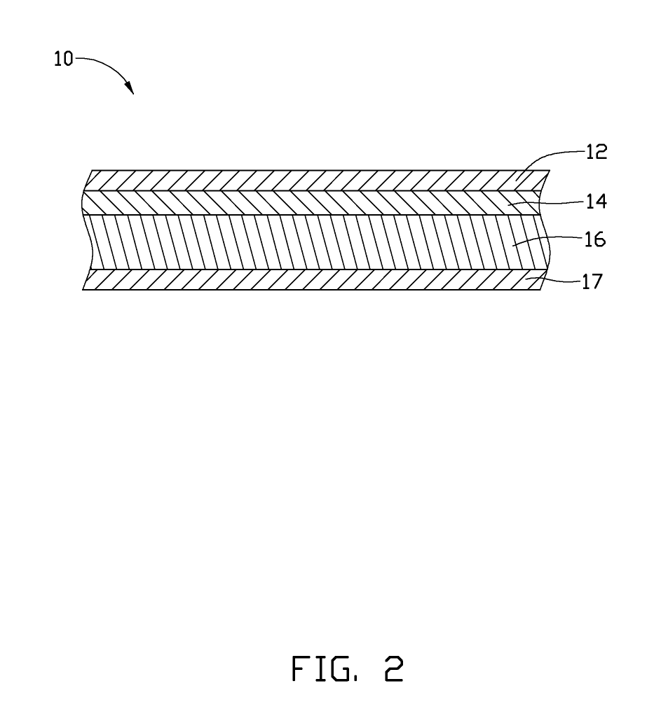

Referring to FIG. 2, the touch screen 10 may be a transparent capacitive touch screen including a transparent protective layer 12, a first conducting layer 14, a transparent main body 16, a second conducting layer 17, a connecting wire 18, and a control module 19. The transparent protective layer 12 may be made of silicon dioxide (SiO) or polyethylene terephthalate (PET). The first conducting layer 14 is attached to the transparent protective layer 12, and may be made of indium tin oxide (ITO), aluminum-doped zinc oxide, or cadmium oxide (CdO). The first conducting layer 14 is configured for detecting a touching position. The transparent main body 16 is attached to the first conducting layer 14, and may be made of transparent glass or transparent plastic. The second conducting layer 17 is coated on the transparent main body 16, and may be made of transparent conducting material for shielding the transparent main body 16. The connecting wire 18 connects the touch screen 10 to a computer. The control module 19 may be an integrated chip disposed on the connecting wire 18 and is electrically connected to the first conducting layer 14, the second conducting layer 17 and the connecting wire 18 by flexible cables (not shown). When the users presses the transparent protective layer 12 to, e.g., write something, the control module 19 can detect a touching position coordinate made by the users, and produce a corresponding command signal to the electronic device.

The writing pad 20 can be made of transparent material, and may be adhered to an end of the touch screen 10. The writing pad 20 is electrically connected to the control module 19 by flexible cables. A track signal acted by the users touching on the writing pad 20 is transmitted to the electronic device by the control module 19.

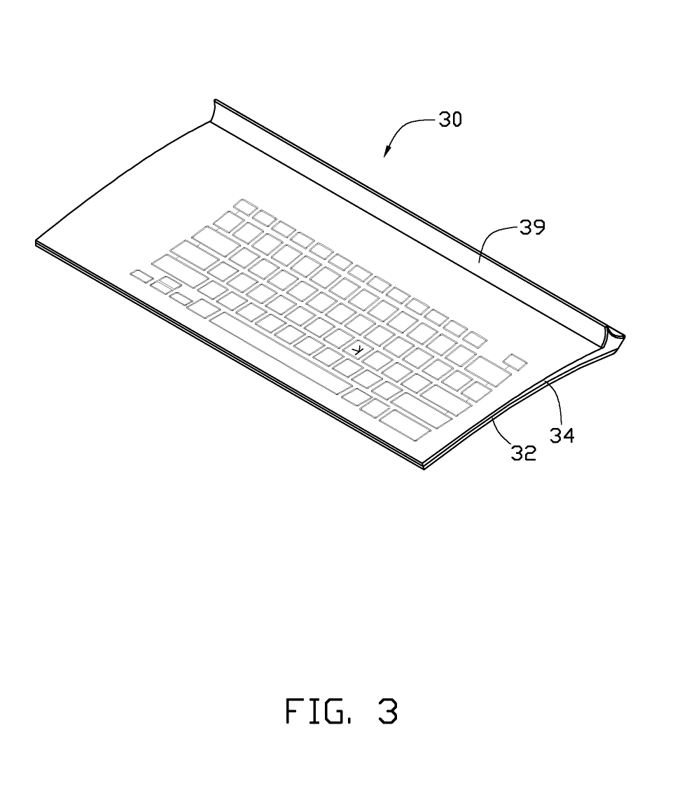

Referring FIG. 3, the transparent plate 30 can be made of transparent glass or transparent resin, and is configured for supporting the writing pad 20 and the touch screen 10. The transparent plate 30 includes a first plate 32 and a second plate 34 combined with the first plate 32. The first plate 32 adheres to the second conducting layer 17. A plurality of key icons 36 and a driver circuit 38 are disposed on the second plate 34 adjacent to the first plate 32. The key icons 36 are made of transparent electroluminescence material printed or spray painted on the second plate 34. The key icons 36 can illuminate when the touch-type transparent keyboard 100 is powered on. An original coordinate information of the key icons 36 is stored in the controlling module 19 corresponding to touching positions of the touch screen 10. By touching the key icons 36, the users can input a corresponding instruction, such as character, sign or number to the electronic device. In response to the instruction, an image can be shown on a display of the electronic device. The driver circuit 38 can be made of transparent conducting material printed on the second plate 34, and electrically connecting the key icons 36 to the controlling module 19. The driver circuit 38 controls the key icons 36 illuminating. When the driver circuit 38 is powered on, the key icons 36 can illuminate. The key icons 36 and the driver circuit 38 are sandwiched between the first plate 32 and the second plate 34, thus the key icons 36 and the driver circuit 38 can be protected.

A supporting portion 39 is positioned on the second plate 34 away from the first plate 32 to support the touch-type transparent keyboard 100. In the exemplary embodiment, the supporting portion 56 is made of transparent material and a cross section of the supporting portion 56 may be substantially triangular.

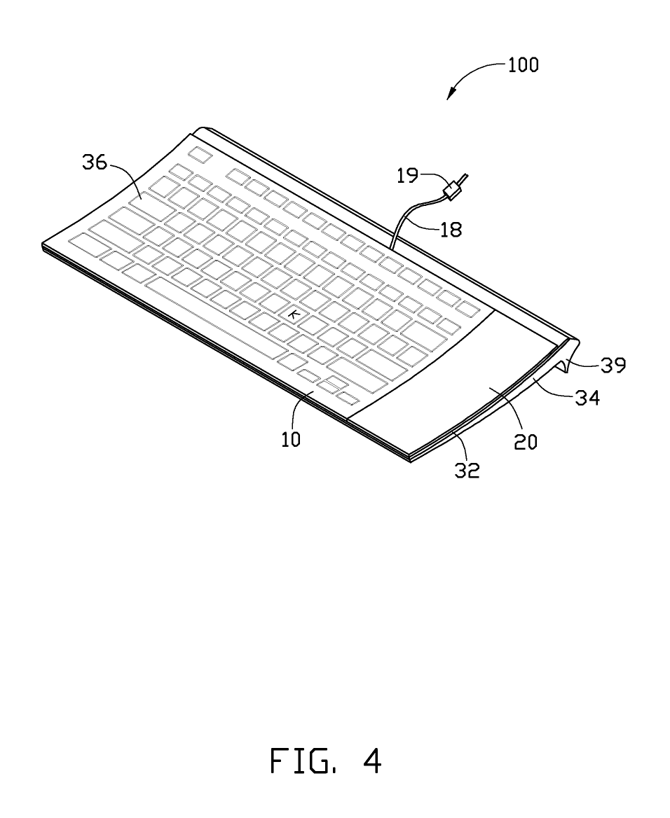

Referring to FIG. 4, when the touch-type transparent keyboard 100 is powered on, the control module 19 triggers the driver circuit 38 to illuminate the key icons 36 and the key icons 36 are displayed through the touch screen 10. When users touch the touch screen 10, the control module 19 detects the touching position and records coordinate information corresponding to the touching position. Then, the control module 19 compares the coordinate information and the coordinate information of the key icons 36 to output the command signal corresponding to the touching position. Meanwhile, the users also can input track signal, such as characters and graphics by the writing pad 20. Thereby, the track signal is transmitted to the electronic device.

In another exemplary embodiment, the touch-type transparent keyboard 100 can be a wireless keyboard, the control module 19 can be disposed on a sidewall of the touch screen 10, and made of transparent material.

In another exemplary embodiment, the touch screen 10 also can be a resistance-type touch screen or a surface acoustic wave touch screen.

The touch-type transparent keyboard 100 adopts the touch screen 10 and the writing pad 20 covering on the transparent plate 30. Therefore, when typing the touch-type transparent keyboard 100, there is no noise produced. There are no mechanical keys defining the gaps therebetween. Thus, contaminants are easily avoided. Furthermore, the key icons 36 and the driver circuit 38 are sandwiched between the first plate 32 and the second plate 34, thus the key icons 36 and the driver circuit 38 can be protected.

It is to be understood, however, that even through numerous characteristics and advantages of the present disclosure have been set forth in the foregoing description, together with details of the structure and function of the disclosure, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. A touch-type transparent keyboard, comprising:
a touch screen;
a control module electrically connected to the touch screen;
a transparent plate comprising a plurality of key icons and a driver circuit electrically connecting the key icons to the control module; and
a writing pad and the touch screen disposed on the transparent plate, the writing pad electrically connected to the control module;
wherein the control module triggers the driver circuit to control the illumination of the key icons, whereby, the key icons are displayed through the touch screen.

2. The touch-type transparent keyboard as claimed in claim 1, the transparent plate comprises a first plate and a second plate combined with the first plate; the first plate may be adhered to the touch screen, and the control module and the key icons are sandwiched between the first plate and the second plate.

3. The touch-type transparent keyboard as claimed in claim 2, wherein the key icons are printed or spray painted on the second plate.

4. The touch-type transparent keyboard as claimed in claim 2, wherein the driver circuit is made of transparent conducting material printed on the second plate.

5. The touch-type transparent keyboard as claimed in claim 1, wherein the transparent plate is made of transparent glass or transparent resin.

6. The touch-type transparent keyboard as claimed in claim 5, wherein the transparent plate comprises a transparent supporting portion positioned on the transparent plate, a cross section of the supporting portion is triangular.

7. The touch-type transparent keyboard as claimed in claim 1, further comprising a connecting wire connected to the touch screen, the control module connected to the connecting wire.

8. The touch-type transparent keyboard as claimed in claim 7, wherein the touch screen comprises a transparent protective layer, a first conducting layer, a transparent main body, a second conducting layer, a connecting wire stacked in turn; the control module electrically connects to the first conducting layer, the second conducting layer, and the connecting wire.

9. The touch-type transparent keyboard as claimed in claim 1, wherein the control module stores coordinate information associated with the key icons and corresponding to touching positions of the touch screen.

10. A touch-type transparent keyboard for use with an electronic device, the touch-type transparent keyboard comprising:
a touch screen;
a control module electrically connected to the touch screen;
a transparent plate comprising a plurality of key icons;
a writing pad and the touch screen disposed on the transparent plate, the writing pad electrically connected to the control module; and
wherein when a touching position corresponding to the key icons of the touch screen are touched, the control module detects a touching position coordinate and produces a corresponding command signal to the electronic device, and an image is shown on the electronic device; when the writing pad is touched, a track signal is transmitted to the electronic device by the control module.

11. The touch-type transparent keyboard as claimed in claim 10, wherein the transparent plate further comprises a driver circuit electrically connecting the key icons to the control module, the control module triggers the driver circuit to illuminate the key icons, whereby, the key icons are displayed through the touch screen.

12. The touch-type transparent keyboard as claimed in claim 11, wherein the transparent plate comprises a first plate and a second plate combined with the first plate; the first plate may be adhered to the touch screen, and the control module and the key icons are sandwiched between the first plate and the second plate.

13. The touch-type transparent keyboard as claimed in claim 11, wherein the key icons are printed or spray painted on the second plate.

14. The touch-type transparent keyboard as claimed in claim 11, wherein the driver circuit is made of transparent conducting material printed on the second plate.

15. The touch-type transparent keyboard as claimed in claim 10, the transparent plate is made of transparent glass or transparent resin.

16. The touch-type transparent keyboard as claimed in claim 15, wherein the transparent plate comprises a transparent supporting portion positioned on the transparent plate, a cross section of the supporting portion is triangular.

17. The touch-type transparent keyboard as claimed in claim 10, further comprising a connecting wire connected to the touch screen, the control module connected to the connecting wire.

18. The touch-type transparent keyboard as claimed in claim 17, wherein the touch screen comprises a transparent protective layer, a first conducting layer, a transparent main body, a second conducting layer, a connecting wire stacked in turn; the control module electrically connects to the first conducting layer, the second conducting layer, and the connecting wire.

19. The touch-type transparent keyboard as claimed in claim 10, wherein the control module stores touching positions coordinate information association with the key icons and corresponding to touching positions of the touch screen.
